(19) United States
(12) Patent Application Publication
(10) Pub. No.: US 2014/0110142 A1
(43) Pub. Date: Apr. 24, 2014

(54) PNEUMATIC TOOL HAVING A TWO-STAGE FLOW CONTROL

(71) Applicant: BASSO INDUSTRY CORP., Taichung (TW)

(72) Inventor: Chiang HUA, Taichung (TW)

(73) Assignee: BASSO INDUSTRY CORP., Taichung (TW)

(21) Appl. No.: 14/050,905

(22) Filed: Oct. 10, 2013

(30) Foreign Application Priority Data
Oct. 19, 2012 (TW) 101138718

(51) Int. Cl. B25F 5/00

(52) U.S. Cl. CPC B25F 5/00
USPC 173/169

(57) ABSTRACT

A pneumatic tool includes a body, a switch valve, and a trigger. The body has a passage. The switch valve includes a plug sealing the passage, a plug rod connected to the plug, and a rod member extending in the body along an axis for driving the plug rod and the plug, such that movement of the rod member in the body in a direction results in a gradual increase in flow rate of the gas in the passage. The plug rod is connected to the rod member such that an angle is formed therebetween. The trigger includes a first plate and a second plate. The first plate is operable manually to covert between a first position whereat the second plate cannot be driven by the first plate, and a second position whereat the second plate can be driven by the first plate.

### CROSS-REFERENCE TO RELATED APPLICATION

This application claims priority of Taiwanese Application No. 101138718, filed on Oct. 19, 2012.

### BACKGROUND OF THE INVENTION

1. Field of the Invention

This invention relates to a pneumatic tool, and more particularly to a pneumatic tool having a two-stage gas flow control.

2. Description of the Related Art

Referring to FIGS. 1 and 2, a pneumatic tool disclosed in Taiwanese Patent Publication No. M396733 includes a body 11, a passage 12 formed in the body 11 for guiding entry of a gas, a switch valve 13 extending through the passage 12 along an axis (X), and a trigger 14 disposed movably on the body 11. The switch valve 13 includes a pin 131 connected co-rotatably to the trigger 14, and a gas blocking member 132 disposed on the pin 131 for sealing an end of the passage 12.

Upon application of an external force to the trigger 14, the trigger 14 moves along the axis (X) so that the pin 131 activates the gas blocking member 132 to open the passage 12, so that a first-stage movement of the pin 131 is ended. Subsequently, when movement of the pin 131 is continued, i.e., a second-stage movement of the pin 131 occurs, the opening degree of the passage 12 is increased gradually. By such a two-stage movement, the flow rate of the passage can be controlled.

However, since the gas blocking member 132 is disposed on the pin 131, and since the pin 131 is co-rotatable with the trigger 14, the pressure of the gas flowing in the passage 12 forms a resistance to movement of the pin 131 and the trigger 14, thereby resulting in difficulties in actuation of the trigger 14. As such, to open the passage 12, it is necessary to apply a comparatively large force to the trigger 14, thereby resulting in difficulties in controlling the second-stage movement of the pin 131.

Referring to FIG. 3, another conventional pneumatic tool 2 includes a body 21, and a trigger 22 that is rotatable to perform a non-stage gas flow control. Since the trigger 22 is mounted swingably on the body 21, it is easy to actuate. However, since the swinging movement of the trigger 22 is converted into a straight movement of another element, the trigger 22 needs to be rotated by a relatively large angle. Furthermore, in this manner, the gas flow rate is difficult to control, and a finger may be clamped between the trigger 22 and the body 21.

### SUMMARY OF THE INVENTION

The object of this invention is to provide a two-stage gas flow control for a pneumatic tool, which can control the gas flow rate in an easy and more accurate manner and which can be operated smoothly.

According to this invention, a pneumatic tool includes a body, a switch valve, and a trigger. The body has a passage. The switch valve includes a plug sealing the passage, a plug rod connected to the plug, and a rod member extending in the body along an axis for driving the plug rod and the plug, such that movement of the rod member in the body in a direction results in a gradual increase in the flow rate of the gas in the passage. The plug rod is connected to the rod member. The trigger includes a first plate and a second plate. The first plate is operable manually to covert between a first position whereat the second plate cannot be driven by the first plate, and a second position whereat the second plate can be driven by the first plate.

Since the plug is not disposed directly on the rod member, the pressure of the gas flowing in the passage cannot affect smooth operation of the trigger. Furthermore, since the trigger includes the first and second plates, and since the second-stage movement of the rod member is started upon activation of the second plate, the second-stage movement of the rod member can be controlled easily.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 a sectional view of a conventional pneumatic tool disclosed in Taiwanese Patent Publication NO. M396733, having a movable trigger, illustrating that a gas passage is closed;

FIG. 2 is a view similar to FIG. 1 but illustrating that the gas passage is opened;

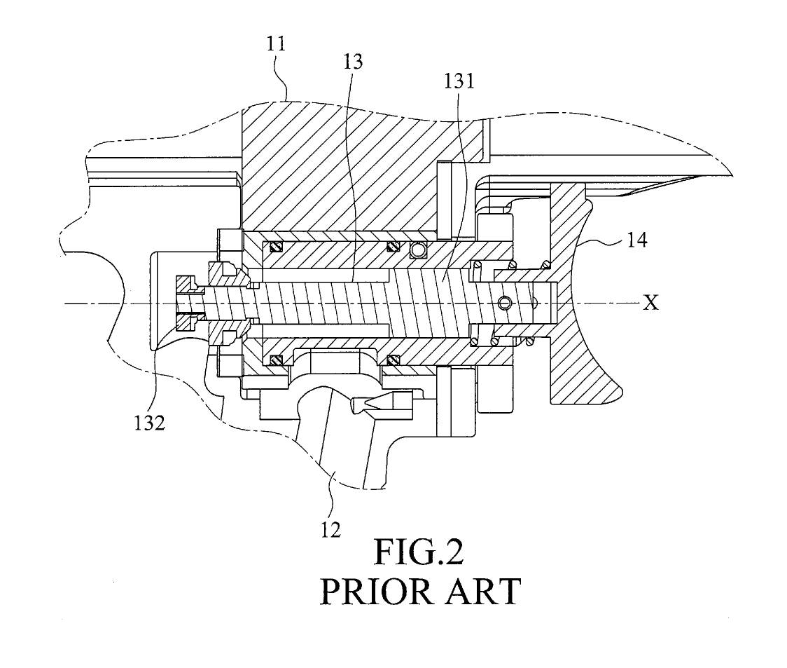

FIG. 3 is a side view of another conventional pneumatic tool having a pivotable trigger;

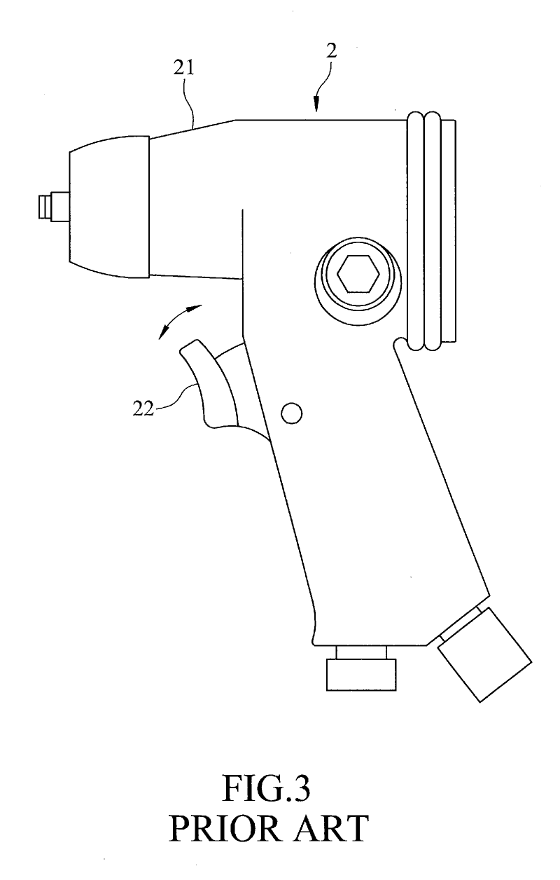

FIG. 4 is a sectional view of the first preferred embodiment of a pneumatic tool according to this invention, illustrating that a rod member is not activated;

FIG. 5 is a view similar to FIG. 4 but illustrating a first-state movement of the rod member;

FIG. 6 is a view similar to FIG. 4 but illustrating a second-stage movement of the rod member;

FIG. 7 is a partly exploded sectional view of the second preferred embodiment of a pneumatic tool according to this invention;

FIG. 8 is an assembled sectional view of the second preferred embodiment, illustrating that a rod member is not activated;

FIG. 9 is a view similar to FIG. 8 but illustrating a first-state movement of the rod member; and

FIG. 10 is a view similar to FIG. 8 but illustrating a second-stage movement of the rod member.

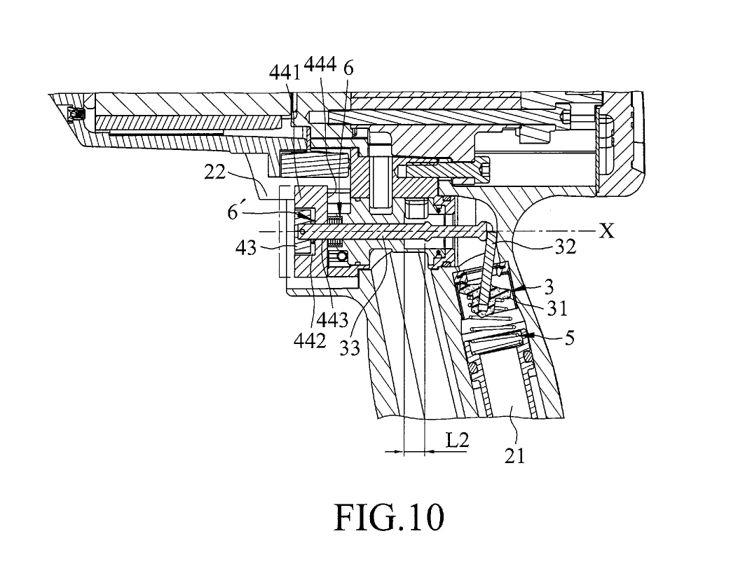

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

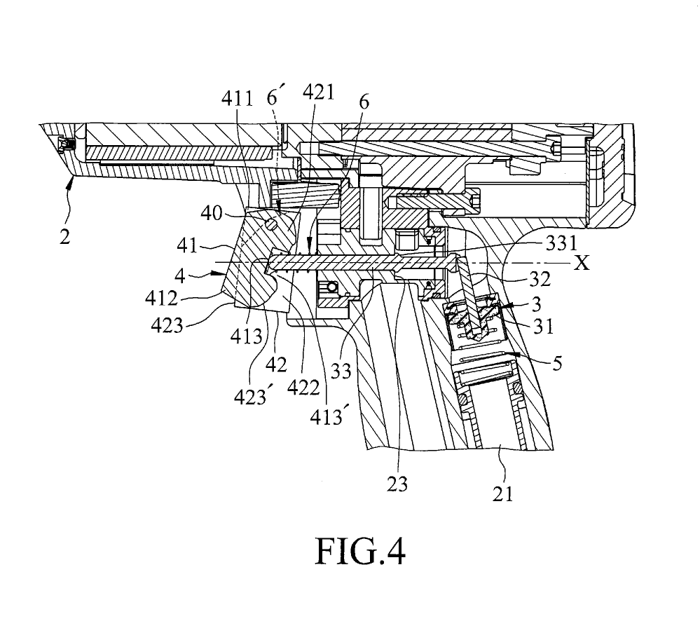

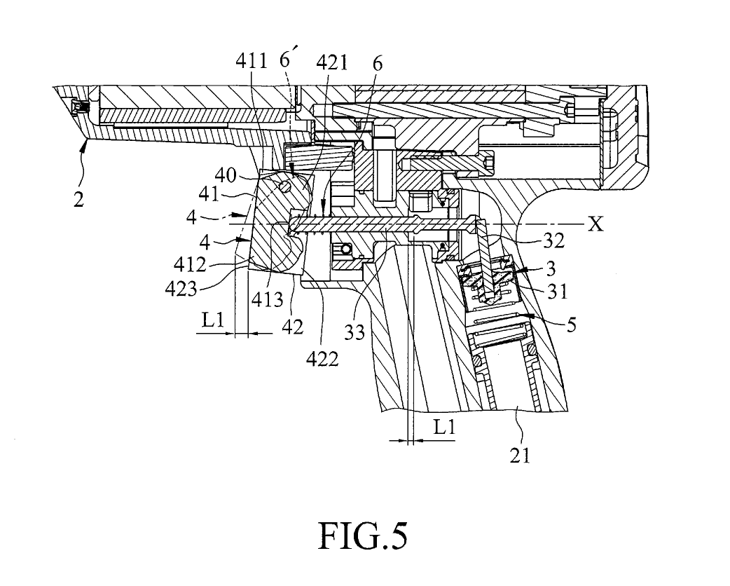

Referring to FIGS. 4 and 5, the first preferred embodiment of a pneumatic tool according to this invention includes a body 2, a switch valve 3, a trigger 4, a first resilient member 5, a second resilient member 6, and a third resilient member 6′.

The body 2 has a passage 21 permitting a gas to flow there through.

The switch valve 3 includes a plug 31 sealing the passage 21, a plug rod 32 connected to the plug 31, and a rod member 33 extending in the body 2 along an axis (X) and movable for driving the plug rod 32 and the plug 31. The plug rod 32 is connected to the rod member 33 such that an angle is formed therebetween.

The trigger 4 includes a pivot pin 40, a first plate 41, and a second plate 42. Each of the first and second plates 41, 42 has a connecting portion 411, 421 adjacent to an end thereof, and a swinging portion 412, 422 adjacent to an opposite end thereof. The swinging portion 412 of the first plate 41 has a periphery formed with a notch 413, and an abutment surface 413′ defining the notch 413 so that an end of the rod member 33 is disposed movably within the notch 413, and abuts against the abutment surface 413′. The second plate 42 further has a depression 423 and an inner wall surface 423′ defining the depression 423. The pivot pin 40 extends through the connecting portions 411, 421 of the first and second plates 41, 42, so that the first and second plates 41, 42 are rotatable about a rotating axis. The pivot pin 40 has a central axis constituting the rotating axis.

The first resilient member 5 is configured as a coiled compression spring, and is disposed between the body 2 and the plug 31 for biasing the plug 31 to seal the passage 21.

The second resilient member 6 is configured as a coiled compression spring, and is disposed between the body 2 and the second plate 42, so as to bias the swinging portion 412 of the first plate 41 to project outwardly from the body 2 for manual operation, so that the first plate 41 is disposed at a first position shown by the phantom lines in FIG. 5. The second resilient member 6 cooperates with the first resilient member 5 to bias a flange 331 of the rod member 33 to contact a positioning surface 23 of the body 2.

The third resilient member 6′ is configured as a torsion spring, and is disposed between the first and second plates 41, 42 for biasing the swinging portion 412 of the first plate 41 away from the swinging portion 422 of the second plate 42. The spring force of the third resilient member 6′ is smaller than that of the second resilient member 6.

An external force can be applied to the first plate 41 of the trigger 4 to overcome the spring force of the third resilient member 6′ to rotate the first plate 41 about the pivot pin 40 from the first position to a second position shown by the solid lines in FIG. 5, where the first plate 41 engages fittingly the depression 423, such that the first plate 41 comes into contact with the inner wall surface 423′. At the same time, the rod member 33 is pushed by the abutment surface 413 to move along the axis (X) by a first distance (L1). That is, a first-stage movement of the rod member 33 is ended by engagement between the first plate 41 and the depression 423, and thus can be realized by the user. At this time, the plug 31 is moved to a position shown in FIG. 5 so that the passage 21 is opened to a predetermined degree.

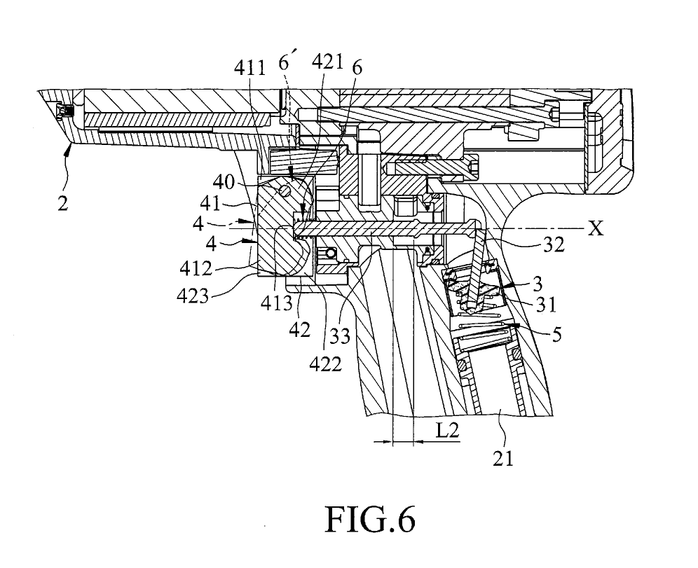

Subsequently, with further reference to FIG. 6, when a larger flow rate of the gas in the passage 21 is required, rotation of the first plate 41 is continued so that the first and second plates 41, 42 rotate synchronously about the pivot pin 40 to thereby move the rod member 33 along the axis (X) by a second distance (L2), such that movement of the rod member 33 results in a gradual increase in flow rate of the gas in the passage 21. At this time, a second-stage movement of the rod member 33 is ended.

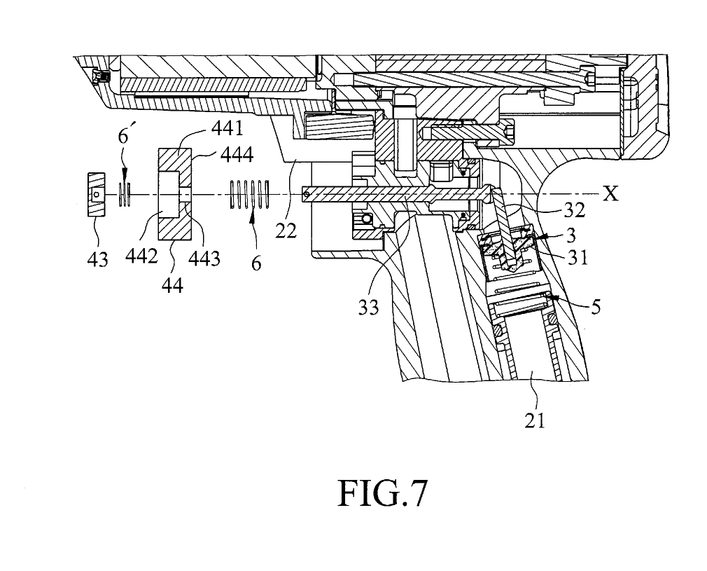

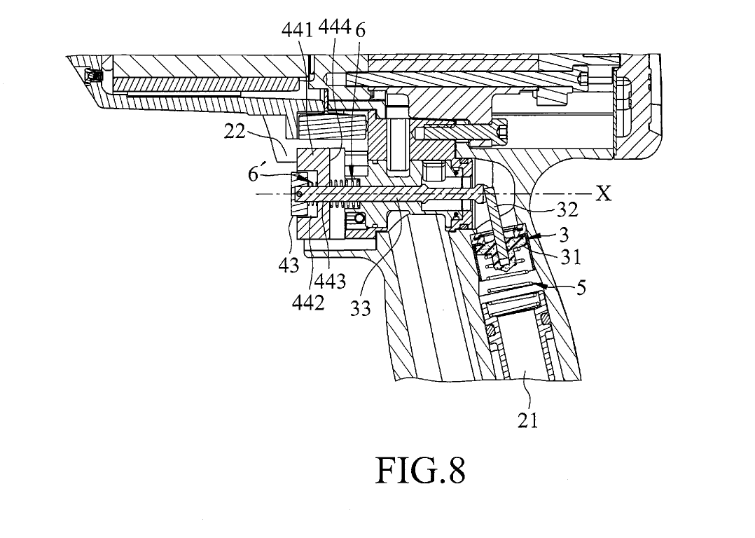

FIGS. 7 and 8 show the second preferred embodiment of a pneumatic tool according to this invention, which is similar in construction to the first preferred embodiment.

In this embodiment, the body 2 further has a track 22 extending in a direction parallel to the axis (X), and the trigger 4 includes a first plate 43 and a second plate 44 that has a connecting portion 441 engaging movably the track 22, a recess 442, and a through hole 443 in spatial communication with the recess 442. The first plate 43 is disposed within the recess 442. The rod member 33 extends through the through hole 443 to connect with the first plate 43. As such, the first and second plates 43, 44 are movable along the axis (X).

Each of the second and third resilient members 6, 6′ is configured as a coiled compression spring. The second resilient member 6 is disposed between the body 2 and the second plate 44. The third resilient member 6′ is disposed between the first and second plates 43, 44 and in the recess 442.

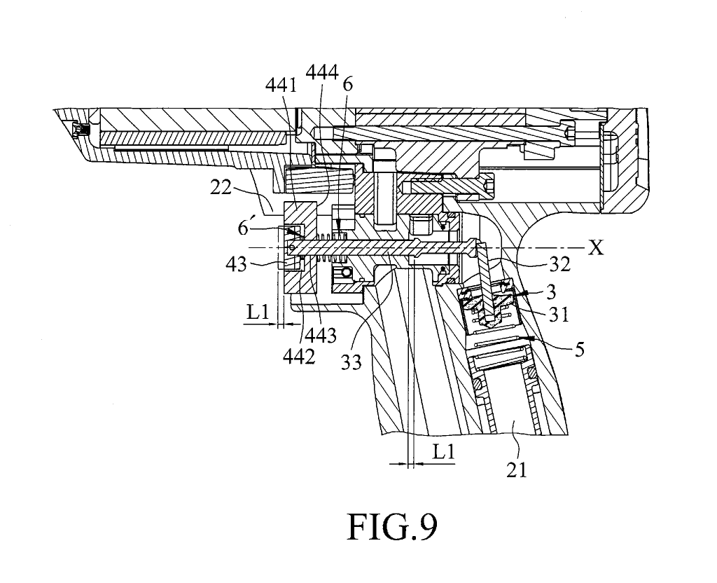

With further reference to FIG. 9, at the first-stage, an external force is applied to drive rectilinear movement of the first plate 43 in the recess 442 in the second plate 44 against the biasing action of the third resilient member 6′ until the third resilient member 6′ cannot be further compressed. At the same time, the rod member 33 is moved by a first distance (L1). The rectilinear movement of the first and second plates 43, 44 is different from rotation of the first and second plates 41, 42 (see FIGS. 4, 5, and 6) in the first preferred embodiment.

At the second stage, application of the external force to the first plate 43 is continued to move the first and second plates 43, 44 and, thus, the rod member 33 along the axis (X) by a second distance (L2).

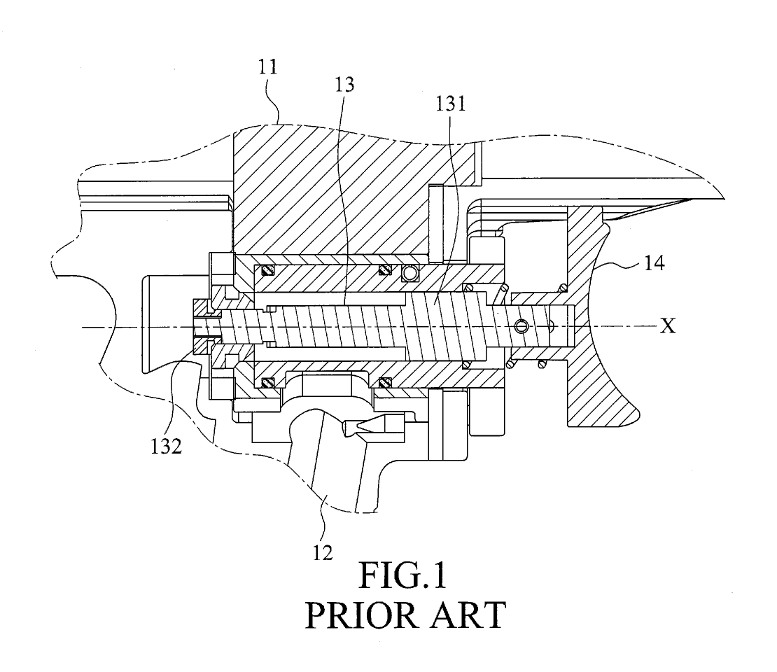

In view of the above, the pneumatic tool of this invention has the following advantages:
1. Since no gas-blocking structure is disposed on the rod member 33, the pressure of the gas in the passage 21 cannot form a resistance to the two-stage movement of the rod member 33, so that the trigger 4 can be operated smoothly.
2. since the trigger 4 includes the first plate 41, 43 and the second plate 42, 44, and since the second-stage movement of the rod member 33 is started upon activation of the second plate 42, 44, the second-stage movement of the rod member 33 can be controlled easily.
3. In the first preferred embodiment, since the first and second plates 41, 42 are rotatable, the distance travelled by the second plate 42 is smaller than that travelled by the trigger 14 (see FIG. 1) of the above-mentioned conventional pneumatic tool, and the volume of a portion of the trigger 4 projecting from the body 2 can be reduced.

With this invention thus explained, it is apparent that numerous modifications and variations can be made without departing from the scope and spirit of this invention. It is therefore intended that this invention be limited only as indicated by the appended claims.

I claim:

1. A pneumatic tool comprising:
a body having a passage adapted to permit a gas to flow therethrough;
a switch valve including a plug sealing said passage, a plug rod connected to said plug, and a rod member extending in said body along an axis for driving said plug rod and said plug, such that movement of said rod member in said body in a direction results in a gradual increase in flow rate of the gas in said passage, said plug rod being connected to said rod member such that an angle is formed therebetween; and
a trigger mounted on said body and connected to said rod member, said trigger including a first plate and a second plate, said first plate being operable manually to covert between a first position whereat said second plate cannot be driven by said first plate, and a second position whereat said second plate can be driven by said first plate, conversion of said first plate from said first position to said second position resulting in movement of said rod member in said body along said axis in the direction by a first distance, after which said first plate is operable manually such that said second plate is driven by said first plate to move said rod member along said axis in the direction by a second distance.

2. The pneumatic tool as claimed in claim 1, further comprising a first resilient member disposed between said body and said switch valve for biasing said plug to seal said passage.

3. The pneumatic tool as claimed in claim 2, wherein said first and second plates are rotatable about a rotating axis.

4. The pneumatic tool as claimed in claim 3, wherein said trigger further includes a pivot pin, each of said first and second plates having a connecting portion adjacent to an end thereof, and a swinging portion adjacent to an opposite end thereof, said pivot pin extending through said connecting portions of said first and second plates and having a central axis constituting said rotating axis.

5. The pneumatic tool as claimed in claim 4, wherein said swinging portion of said first plate has a periphery formed with a notch, and an abutment surface defining said notch, said rod member having an end that is disposed movably within said notch and that abuts against said abutment surface, said second plate further having a depression and an inner wall surface defining said depression, said swinging portion of said first plate being pivotable into said depression to contact said inner wall surface so as to allow for synchronous rotation of said first and second plates.

6. The pneumatic tool as claimed in claim 3, further comprising a second resilient member disposed between said first plate and said body for biasing said swinging portion of said first plate to project outwardly from said body for manual operation.

7. The pneumatic tool as claimed in claim 2, wherein said first and second plates are movable in said body along said axis.

8. The pneumatic tool as claimed in claim 7, wherein said body further has a track extending in a direction parallel to said axis, said second plate having a connecting portion engaging movably said track.

9. The pneumatic tool as claimed in claim 7, wherein said second plate is formed with a recess, and a through hole in spatial communication with said recess, said first plate being disposed within said recess, said rod member extending through said through hole to connect with said first plate.

10. The pneumatic tool as claimed in claim 7, further comprising a second resilient member disposed between said first and second plates for biasing said first plate to project outwardly from said recess.
